(19) United States
(12) Patent Application Publication
(10) Pub. No.: US 2006/0213298 A1
(43) Pub. Date: Sep. 28, 2006

(54) Electrically driven linear actuator

(75) Inventor: Koji Tateishi, Shizuoka-ken (JP)

Correspondence Address: HARNESS, DICKEY & PIERCE, P.L.C., P.O. BOX 828, BLOOMFIELD HILLS, MI, 48303, US

(73) Assignee: NTN Corporation

(21) Appl. No.: 11/386,987

(22) Filed: Mar. 22, 2006

(30) Foreign Application Priority Data
Mar. 22, 2005 (JP) 2005-081815

(51) Int. Cl. F16H 25/22

(52) U.S. Cl. 74/89.23

(57) ABSTRACT

An electrically driven linear actuator, which can suppress the generation of vibration or noise even if an alternating load or vibratory load is applied to the actuator, has an electric motor mounted on a housing. A screw shaft is coaxially connected to a motor shaft of the electric motor. The screw shaft is formed with a screw groove on its outer circumferential surface. A nut, threadably engaged with the screw shaft, has a pair of support shafts on its outer circumferential surface. The support shafts support one end of a link. The nut is formed with a screw groove on its inner circumferential surface. The nut screw groove corresponds to the screw groove of the screw shaft. A number of balls are contained between the screw grooves. Ball circulating members are coupled with the nut. Each ball circulating member is formed with an endless ball circulating passage between the screw grooves. The ball screw converts a rotary motion of the electric motor to an axial motion of the nut, in turn, causing a swing motion of the link, via the support shafts. A pair of support bearings rotatably supports the screw shaft in the housing. However, the screw shaft is axially immovably supported relative to the housing. One supporting bearing, arranged at the electric motor side, of each pair of the supporting bearing is an angular ball bearing. The other support bearing is a sliding bearing.

### CROSS-REFERENCE TO RELATED APPLICATION

This application claims priority to Japanese Patent Application No. 2005-081815, filed Mar. 22, 2005, which application is herein expressly incorporated by reference.

### FIELD

The present invention relates to an electrically driven linear actuator used in a drive train such as a brake, engine or transmission of an automobile, and more particularly, to an electrically driven linear actuator to convert a rotary motion of an electric motor to a linear motion, via a ball screw mechanism.

### BACKGROUND

Electrically driven linear actuators used in driving mechanisms of a vehicle such as an automobile etc, usually uses a gear mechanism. The gear mechanism includes a trapezoidal screw thread or a rack and pinion as the mechanism to convert the rotary motion of the electric motor to a linear motion in an axial direction. These converting mechanisms usually have sliding contact portions and thus a chance for power loss. This loss requires an increase of power of the electric motor which, in turn, increases the power consumption. Accordingly, ball screw mechanisms have an increasing use as a more efficient actuator.

Heretofore, in such an electrically driven linear actuator, a line of action of the driving side coincides with an axis of the ball screw. Thus, a pure axial load is applied to the ball screw. However, if the load applied to the ball screw is not a pure axial load, an appropriate means, such as a linear guide, is used to prevent the load from being directly applied to the ball screw.

In industrial machines used for general purposes, a relatively large space exists for actuators and thus a large degree of freedom is present for an arrangement and size of structural parts of the electrically driven linear actuator. On the contrary, space and the degree of freedom to mount the electrically driven actuators are strictly limited in the case of an engine compartment of an automobile. Thus, it is very difficult to incorporate electrically driven linear actuators which are structured to receive only pure axial loads applied on the ball screw.

The electrically driven linear actuator shown in FIG. 5 is used to solve such a problem. This electrically driven linear actuator 50 generally includes a pair of links 51, a ball screw 52, to swingably drive a driven member via the links 51, and an electric motor 53 to drive the ball screw 52.

As shown in FIG. 6, the ball screw 52 includes a screw shaft 54 rotationally driven by the electric motor 53. A nut 55 is formed with a helical screw groove 55a on its inner circumferential surface. The helical screw groove 55a corresponds to the screw groove 54a formed on the outer circumferential surface of the screw shaft 54. A number of balls 56 are contained between the screw grooves 54a and 55a. A supporting shaft 57 pivotably supports the link 51 at one end. The shaft 57 is mounted on the nut 55 as shown in FIG. 5. The supporting shaft 57 is arranged so that it passes through the center of gravity of the nut 55 and is perpendicular to the axis of the screw shaft 54.

The ball screw 52 also includes a return tube 58 (see FIG. 6) as a ball circulating member. The ball circulating member forms an endless circulating passage to circulate the balls 56 between the screw grooves 54a and 55a. The return tube 58 is mounted on the nut 55 at a side (a lower side in FIG. 6) opposite to a side (an upper side in FIG. 6) on which a radial component force “Fr” of a load “F” acts on the nut 55, via the supporting shaft 57.

Thus, it is possible to arrange a larger number of balls 56 at the upper side of the nut 55, in FIG. 6, than are present at the lower side of the nut 55, in FIG. 6. Thus, it is possible to prevent the reduction of life of the ball screw 52 which would be caused by the radial component force “Fr” of the load “F” acting on the nut 55 via the supporting shaft 57 (see e.g. Japanese Laid-open Patent Publication No. 84827/2004).

In such a prior art electrically driven linear actuator 50, the screw shaft 54 of the ball screw 52 is supported by a pair of deep groove ball bearings 59, 60. However, a problem with the prior art linear actuator ball screw 52 is that vibration or noise is often caused by alternating load or vibratory load as a reaction force from the point of force application.

### SUMMARY

It is an object of the present disclosure to provide an electrically driven linear actuator which can suppress the generation of vibration or noise even if an alternating load or vibratory load is applied to the electrically driven linear actuator.

According to the present disclosure, an electrically driven linear actuator includes an electric motor mounted on a housing. A screw shaft is coaxially connected to a motor shaft of the electric motor. The screw shaft is formed with a screw groove on its outer circumferential surface. A nut is threadably engaged with the screw shaft. The nut has a pair of supporting shafts on its outer circumferential surface. One end of a link is supported on the shafts. A screw groove is formed on the inner circumferential surface of the nut. The nut screw groove corresponds to the screw groove of the screw shaft. A number of balls are contained between the screw grooves. Ball circulating members, each being formed with an endless ball circulating passage between the screw grooves, are positioned on the nut. A ball screw converts a rotary motion of the electric motor to an axial motion of the nut and, in turn, cause a swing motion of the link via the supporting shafts. A pair of supporting bearings rotatably supports the screw shaft. While the screw shaft is rotatable, it is axially immovable relative to the housing. One supporting bearing, arranged at the electric motor side of each pair of the supporting bearings, is an angular ball bearing and the other supporting bearing is a sliding bearing.

The supporting bearing, arranged at the electric motor side of each pair of the supporting bearings, is an angular ball bearing and the other supporting bearing is a sliding bearing. Thus, it is possible to suppress the angular run-out of the supporting bearing at the side obliged to be loaded by the axial load even if an alternating load or vibratory load is applied to the electrically driven linear actuator. In addition, since the sliding bearing has a high rigidity and can accept the elongation of the screw shaft, which is caused by temperature rise during driving of the vehicle, it is possible to further effectively absorb the vibration.

Preferably, a light preload is applied to the ball screw. This enables the ball screw to suppress the increase of the rotational torque and the temperature rise. Also, it suppresses the generation of vibration or noise even if an alternating load or vibratory load is applied to the electrically driven linear actuator.

The angular ball bearing may be a double row angular ball bearing. Also, the angular ball bearing may be a four-point contact ball bearing.

A chamfered surface is formed between the outer circumferential surface of the screw shaft, on which the screw groove is formed, and a journal supported by the sliding bearing. The chamfered surface has an inclined surface angle of about 45° or less than 45° relative to the outer circumferential surface, or axis, of the screw shaft. Accordingly, the difference in diameter of the outer circumferential surface of the screw shaft and the journal can be reduced. Thus, a single coil of material can be used both for induction hardening of the screw groove and the journal. Accordingly, it is possible to reduce the heat treatment step and thus manufacturing costs.

The electrically driven linear actuator comprises an electric motor mounted on a housing. A screw shaft is coaxially connected to a motor shaft of the electric motor. A screw groove is formed on the outer circumferential surface of the screw shaft. A nut, threadably engaged with the screw shaft, has a pair of supporting shafts on its outer circumferential surface. The support shafts support one end of a link. A screw groove is formed on an inner circumferential surface of the nut. The nut screw groove corresponds to the screw groove of the screw shaft. A number of balls are contained between the screw grooves. Ball circulating members, each being formed with an endless ball circulating passage between the screw grooves, are coupled with the nut. The ball screw converts a rotary motion of the electric motor into an axial motion of the nut which causes a swing motion of the link connected via the supporting shafts. A pair of supporting bearings rotatably supports the screw shaft in the housing. However, the screw shaft is axially immovably relative to the housing. One supporting bearing, arranged at the electric motor side, of each pair of the supporting bearings, is an angular ball bearing. The other supporting bearing is a sliding bearing. Accordingly, it is possible to suppress the angular run-out of the supporting bearing at the side obliged to receive the axial load. Thus, the generation of vibration or noise is suppressed even if an alternating load or vibratory load is applied to the electrically driven linear actuator. In addition, since the sliding bearing has a high rigidity and can accept the elongation of the screw shaft, which is caused by temperature rise during driving of the vehicle, it is possible to further effectively absorb vibration.

An electrically driven linear actuator comprises an electric motor mounted on a housing. A screw shaft is coaxially connected to a motor shaft of the electric motor. The screw shaft is formed with a screw groove on its outer circumferential surface. A nut, threadably engaged with the screw shaft, has a pair of supporting shafts on its outer circumferential surface. The supporting shafts support one end of a link. A screw groove is also formed on an inner circumferential surface of the nut. The nut screw groove corresponds to the screw groove of the screw shaft. A number of balls are contained between the screw grooves. Ball circulating members, each being formed with an endless ball circulating passage between the screw grooves, are coupled with the nut. The ball screw converts a rotary motion of the electric motor into an axial motion of the nut which, in turn, causes a swing motion of the link, via the supporting shafts. A pair of supporting bearings rotatably supports the screw shaft in the housing. However, the screw shaft is axially immovable relative to the housing. One supporting bearing, arranged at the electric motor side, of each pair of the supporting bearings, is an angular ball bearing. The other supporting bearing is a sliding bearing. A chamfered surface is formed between the outer circumferential surface of the screw shaft, on which the screw groove is formed, and a journal supported by the sliding bearing. The chambered surface has an inclined surface angle of 45° or less.

Further areas of applicability will become apparent from the description provided herein. It should be understood that the description and specific examples are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1 is a longitudinal section view of a first embodiment of the electrically driven linear actuator.

FIG. 2(a) is a longitudinal section view of a ball screw of FIG. 1.

FIG. 2(b) is a perspective view of a bridge member of FIG. 2(a).

FIG. 3 is an partially enlarged elevation view of a screw shaft of the present disclosure.

FIG. 4 is a longitudinal section view of a second embodiment of the electrically driven linear actuator.

FIG. 5 is a front elevation view, partially sectioned, of a prior art electrically driven linear actuator.

FIG. 6 is a longitudinal section view of the ball screw of FIG. 5.

### DETAILED DESCRIPTION

Preferred embodiments of the present invention will be described with reference to the accompanying drawings.

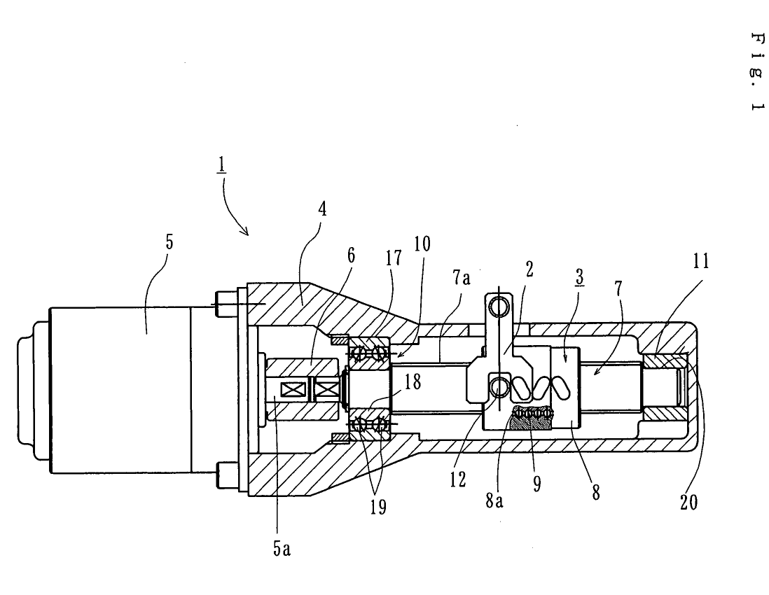

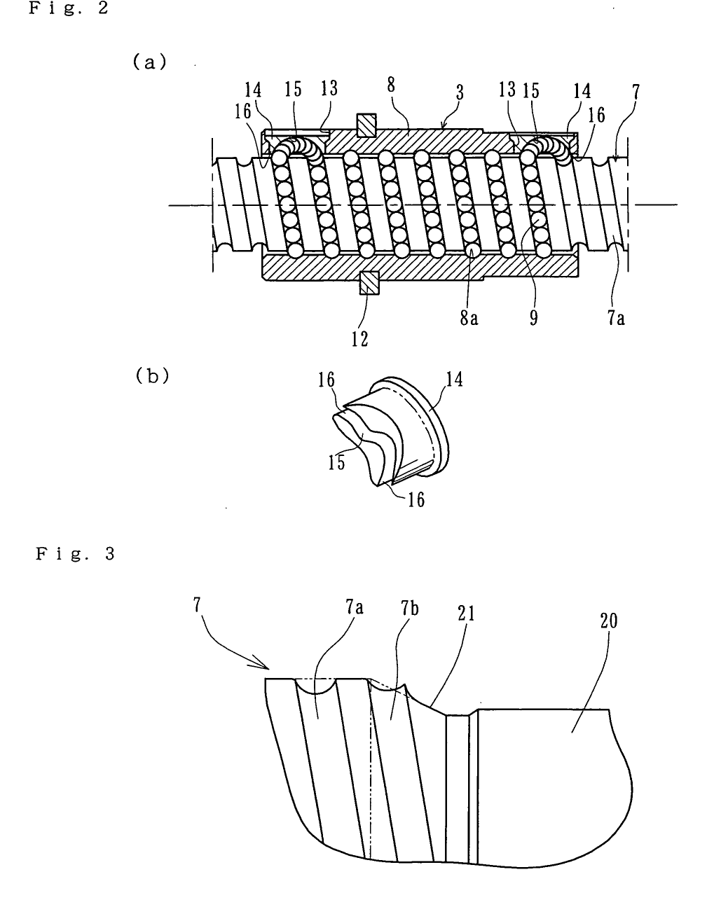

FIG. 1 is a longitudinal section view of a first embodiment of the electrically driven linear actuator. FIG. 2(a) is a longitudinal section view of the ball screw of FIG. 1. FIG. 2(b) is a perspective view of a bridge member of FIG. 2(a). FIG. 3 is a partial enlarged view of a screw shaft of the present disclosure.

The electrically driven linear actuator 1 has a link 2, a ball screw 3, and an electric motor 5. The ball screw 3 swingably drives a driven member (not shown) via the link 2. The electric motor 5 is mounted on a housing 4 to drive a screw shaft 7.

The ball screw 3 is coaxially connected to a motor shaft 5a of the electric motor 5 via a coupling 6. As shown in FIG. 2(a), the ball screw 3 includes a screw shaft 7 with a screw groove 7a formed on its outer circumferential surface. A nut 8, coupled with the screw shaft 7, is formed with a screw groove 8a on its inner circumferential surface. The nut screw groove 8a corresponds to the screw groove 7a of the screw shaft 7. A number of balls 9 are contained between the screw grooves 7a and 8a. The cross-sectional configuration of the screw grooves 7a and 8a may be either a circular arc or a Gothic arc configuration. However, the Gothic arc configuration is preferred since it enables a large contact angle relative to the balls 9 and also to set a small axial gap in order to increase the rigidity against the axial load and to suppress vibration.

Oval bridge windows 13 are formed through a wall of the barrel of the nut 8. A portion of the screw groove 8a is cut out of the wall. A bridge member 14, having an oval configuration, is fit into each of the bridge windows 13. As shown in FIG. 2(b), the bridge member 14 is formed with a connecting groove 15 to connect the mutually adjacent screw grooves 8a. The connecting groove 15 and substantially one circumferential length of the screw groove 8a form a ball rolling passage. A number of balls 9 are arranged between the inner and outer screw grooves 7a and 8a within the ball rolling passage. The balls 9 roll along the screw grooves 7a and 8a. The balls 9 climb over a land of the screw groove 7a while being guided by the connecting groove 15 of the bridge member 14. The balls 9 return into the adjacent screw groove 7a and again roll along the screw grooves 7a and 8a.

The connecting groove 15 of the bridge member 14 is formed in an “S” configuration. This smoothly connects the adjacent screw grooves 8a of the nut 8. Accordingly, opposite opened edges 16 of the connecting groove 15 are adapted to be connected to the screw groove 8a of the nut 8. Thus, they can correspond to the opened edges of the bridge window 13 of the adjacent screw grooves 8a of the nut 8. The depth of the connecting groove 15 is set so that balls 9 can climb over the land of the screw groove 7a within the connecting groove 15.

The bridge member 14 may be made of sintered alloy formed in a mold of an injection machine by injecting plastically adjusted metal powder. In this injection molding process, first, metal powder and binder, including plastics and wax, are kneaded by a kneading machine. Next, the kneaded material is pelletized. The pellets are fed into a hopper of the injection machine. The bridge members 14 are formed by pressing heat melted pellets into a mold. The metal powder is preferably material able to be sintered such as material comprising “C” (carbon) of 0.3 wt %, “Ni” (nickel) of 1˜2 wt % and the remainder “Fe” (iron). Other injection moldable material such as “PA” (polyamide) may be used for making the bridge member 14.

As shown in FIG. 1, the screw shaft 7 is rotatably supported by a pair of supporting bearings 10 and 11 in the housing 4. However, the screw shaft 7 is axially immovably relative to the housing 4. The nut 8 includes a pair of supporting shafts 12 at an axially central position on the outer circumferential surface of the nut. The support shafts 12 are perpendicular to the axis of the screw shaft 7. Each of the shafts 12 rotatably supports one end of the link 2. Accordingly, the nut 8 is supported to be axially movable but rotationally immovable.

The screw shaft 7 is rotated in accordance with rotation of the electric motor 5. As this occurs, the nut 8 is moved axially (left and right directions in FIG. 1) by the rotation of the screw shaft 7. Thus, the rotary motion of the motor shaft 5a is converted to axial motion of the nut 8 via the ball screw 3. The link 2, connected to the nut 8 via the supporting shaft 12, is swingably moved.

A predetermined light preload is applied to the ball screw 3. Accordingly, a larger diameter is selected for the balls 9 contained between the screw groove 7a and 8a. Thus, it is possible to suppress the generation of vibration or noise even if an alternating load or vibratory load is applied to the ball screw 3. Other structures may be adopted as preload applying means other than selecting balls having a larger diameter. For example, a so-called “double nut type”, where the nut 8 is formed by a pair of nuts and a spacer, as a gap adjuster, is interposed between the pair of nuts. Another example is a type where a preload is applied between the screw shaft 7 and the nut 8 by continuously varying the lead of the screw groove 7a of the screw shaft 7.

The screw shaft 7 is rotatably supported by a pair of supporting bearings 10 and 11 in the housing 4. In the illustrated embodiment, one bearing 10, arranged at a side of the electric motor 5, is a double row angular ball bearing. The other bearing 11, arranged at the journal of the screw shaft 7, is a sliding bearing.

The supporting bearing 10 is a double row angular ball bearing which includes an outer ring 17, inner ring 18 and roller balls 19. The outer ring 17 is formed with double row outer rolling contact surfaces on its inner circumferential surface. The inner ring 18 is formed with double row inner rolling contact surfaces on its outer circumferential surface. The double row balls 19 are rollably contained between the outer and inner rolling contact surfaces. This supporting bearing 10 has a predetermined contact angle which has a loading capacity larger than that of conventionally used deep groove ball bearings. The supporting bearing 10 can suppress the angular run-out. This enables vibration or noise to be suppressed even if an alternating load or vibratory load is applied to the electrically driven linear actuator 1 in combination with the application of a light preload to the ball screw 3.

On the other hand, the supporting bearing 11 is made of high carbon chrome steel such as SUJ2 and treated by dip hardening. Since the supporting bearing 11 is formed by the sliding bearing and has a high rigidity, it is possible to accept the elongation of the screw shaft which is caused by temperature rise during driving of the vehicle and thus to absorb vibration or noise.

The screw shaft 7 is made of medium carbon steel such as S53C including carbon of about 0.40˜0.80 wt % by weight. The screw groove 7a and the journal 20 of the screw shaft 7 are hardened by induction hardening to have desirable wear resistance. As shown in a partially enlarged view in FIG. 3, a chamfered surface 21 is formed on the outer circumferential surface of the screw shaft 7 between the screw groove 7a and a journal 20. The journal 20 is supported by the sliding bearing 11. The chamfered surface 21 has an inclined surface angle of about 45° or less than 45°. Preferably, the angle is about 20˜40° relative to the outer circumferential surface or axis of the screw shaft 7. A numeral 7b denotes an incomplete thread. A two-dot chain line in FIG. 3 denotes a blank configuration of the screw shaft 7 before rolling of the screw groove 7a.

The chamfered surface 21 has a relatively small inclination and is formed on the outer circumferential surface of the screw shaft 7 between the screw groove 7a and a journal 20. Thus, it is possible to reduce the difference in diameter of the outer circumferential surface of the screw shaft 7 and the journal 20. Accordingly, a single coil of material can be used both for induction hardening the screw groove 7a and the journal 20. Thus, it is possible to reduce the heat treatment steps and manufacturing costs. In addition, it is possible to ensure the surface hardness of the journal 20 to be at least 50 HRC and to set the surface hardness of the screw groove 7a at about 58˜64 HRC.

If the chamfered surface on the outer circumferential surface of the screw shaft 7 between the screw groove 7a and the journal 20 is formed in an ordinary manner, a large difference in diameters is present. Accordingly, the surface hardness of the journal 20 would be greatly reduced and cracks would occur at corners of the screw shaft 7 due to excessive heating due to the concentration of eddy current at the edges during induction hardening. However, if the chamfering is carried out under the conditions defined by the present disclosure, the generation of quench cracks can be prevented. Thus, it is possible to continuously carry out the induction hardening without providing any quenching recess.

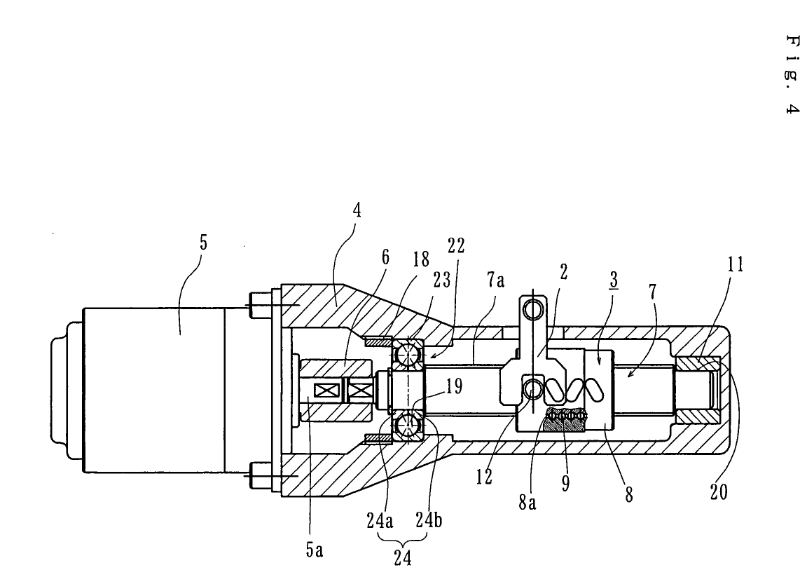

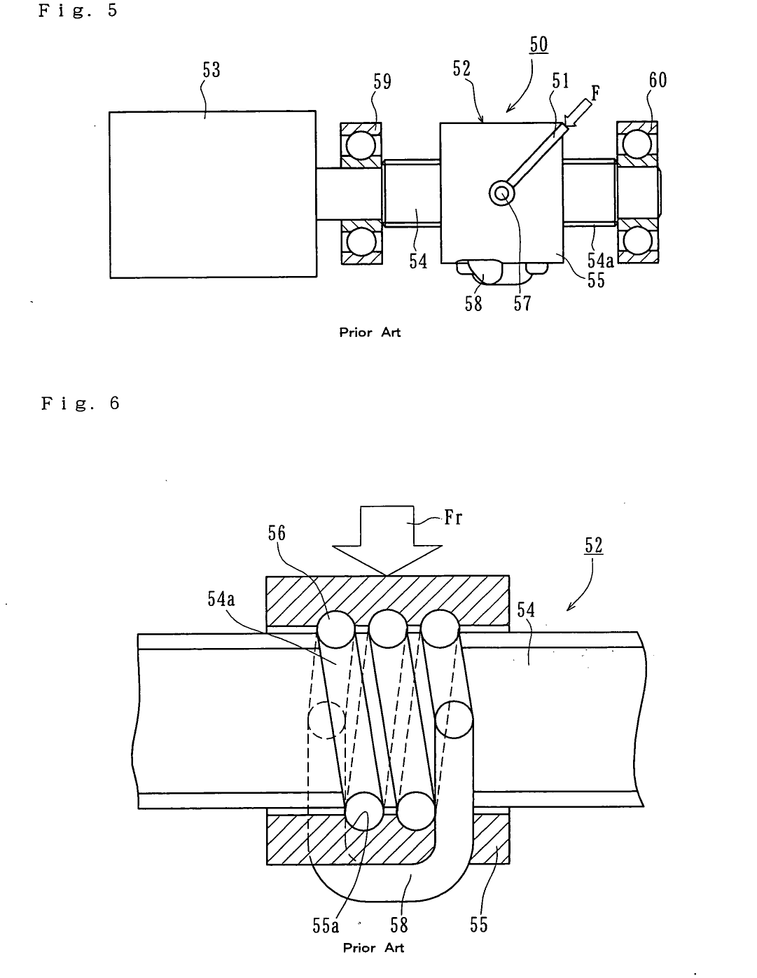

FIG. 4 is a longitudinal section view of a second embodiment of the electrically driven linear actuator. Since this embodiment is different from the first embodiment only in the structure of the supporting bearing, the same reference numerals are used to designate similar parts in both embodiments.

The screw shaft 7 is supported by a supporting bearing 22, including a rolling bearing, and a supporting bearing 11, including a sliding bearing. The screw shaft 7 is rotatable but axially immovably relative to the housing 4. In this second illustrated embodiment, one bearing 22, arranged at a side of the electric motor 5, is a four-point contact ball bearing.

The four-point contact ball bearing 22 includes an outer ring 23, an inner ring 24 and balls 19. The inner ring 24 includes a pair of ring members 24a and 24b abutting each other. The balls 19 are rollably contained between the outer and inner rings 23 and 24.

The cross-sectional configuration of the rolling surface of the outer ring 23 is a so-called Gothic arc configuration. The Gothic arc is formed by a pair of arcs having centers of curvature offset with respect to each other at an equidistant in the axial direction relative to the center of the width of the bearing. On the other hand, the cross-sectional configuration of the rolling surface of the inner ring members 24a and 24b is a circular arc having a predetermined radius of curvature and forms the rolling surface of the Gothic arc configuration while cooperating with each other.

According to the second embodiment, since the supporting bearing 22 is a four-point contact ball bearing and the cross-sectional configuration of the rolling surface of the inner and outer rings is formed as a Gothic arc, it is possible to support axial loads in either directions, even though it is a compact single row ball bearing, and to reduce a range of the axial gap relative to the radial gap of the bearing. Accordingly, it is possible to suppress the generation of vibration or noise even if an alternating load or vibratory load is applied to the ball screw 3.

The present teachings can be applied to electrically driven linear actuators where a ball screw is coaxially connected to the shaft of an electric motor and it converts rotational motion of the motor to an axial motion of a nut engaging a screw shaft of the ball screw. The screw shaft is rotatably supported by support bearings and is axially immovably relative to a housing of the actuator.

The present disclosure has been described with reference to the preferred embodiment. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

What is claimed is:

1. An electrically driven linear actuator comprising:
an electric motor mounted on a housing;
a screw shaft coaxially connected to a motor shaft of the electric motor, said screw shaft formed with a screw groove on its outer circumferential surface;
a nut threadably engaged with the screw shaft, said nut having a pair of supporting shafts on its outer circumferential surface, said supporting shafts supporting one end of a link, said nut formed with a screw groove on its inner circumferential surface, and said nut screw groove corresponding to the screw groove of the screw shaft;
a number of balls contained between the screw grooves;
ball circulating members coupled with said nut, said ball circulating members each being formed with an endless ball circulating passage between the screw grooves;
a ball screw for converting a rotary motion of the electric motor into an axial motion of the nut and causing a swing motion of the link via the supporting shafts; and
a pair of supporting bearings for rotatably supporting the screw shaft in the housing but axially immovably supporting the screw shaft relative to the housing;
one supporting bearing, arranged at the electric motor side, of each pair of the supporting bearings, is an angular ball bearing and the other supporting bearing is a sliding bearing.

2. The electrically driven linear actuator according to claim 1 wherein a light preload is applied to the ball screw.

3. The electrically driven linear actuator according to claim 1 wherein the angular ball bearing is a double row angular ball bearing.

4. The electrically driven linear actuator according to claim 1 wherein the angular ball bearing is a four-point contact ball bearing.

5. The electrically driven linear actuator according to claim 1 wherein a chamfered surface is formed on the outer circumferential surface of the screw shaft between the screw groove and a journal, supported by the sliding bearing, said chamfered surface having an inclined surface angle of about 45° or less than 45° relative to said outer circumferential surface of the screw shaft.
